(19) United States
(12) Patent Application Publication
(10) Pub. No.: US 2020/0207327 A1
(43) Pub. Date: Jul. 2, 2020

(54) CONTROL SYSTEM FOR HYBRID VEHICLE

(71) Applicant: TOYOTA JIDOSHA KABUSHIKI KAISHA, Toyota-shi (JP)

(72) Inventors: Tatsuya IMAMURA, Okazaki-shi (JP); Takahiro YOKOKAWA, Susono-shi (JP); Hideo WATANABE, Toyota-shi (JP); Kazumi HOSHIYA, Gotemba-shi (JP); Hirokazu KATO, Susono-shi (JP); Minoru KATO, Fujinomiya-shi (JP); Kensei HATA, Sunto-gun (JP)

(73) Assignee: TOYOTA JIDOSHA KABUSHIKI KAISHA, Toyota-shi (JP)

(21) Appl. No.: 16/720,592

(22) Filed: Dec. 19, 2019

(30) Foreign Application Priority Data
Dec. 27, 2018 (JP) 2018-244788

(51) Int. Cl. B60W 20/10; B60W 10/06; B60W 10/08; B60W 10/02; B60W 30/18; B60W 10/115; B60K 6/26; B60K 6/365

(52) U.S. Cl. CPC B60W 20/10; B60W 10/06; B60W 10/08; B60W 10/02; B60W 30/18; B60W 10/115; B60Y 2200/92; B60K 6/365; B60W 2710/021; B60W 2710/06; B60W 2710/083; B60W 2710/10; B60K 6/26

(57) ABSTRACT

A control system for a hybrid vehicle configured to smoothly engage an engagement device while reducing a collision noise of the engagement device. The control system is configured to apply torque to a set of teeth on one half of the engagement device to shift a phase of the set of teeth in the event of teeth interference. After the completion of engagement of the engagement device, the control system further applies torque to the set of teeth on one half of the engagement device to reduce backlash between the set of teeth on one half of the engagement device and a set of teeth on the other half of the engagement device.

### CROSS-REFERENCE TO RELATED APPLICATIONS

The present disclosure claims the benefit of Japanese Patent Application No. 2018-244788 filed on Dec. 27, 2018 with the Japanese Patent Office, the disclosures of which are incorporated herein by reference in its entirety.

### BACKGROUND

### Field of the Disclosure

Embodiments of the present disclosure relate to the art of a control system for a hybrid vehicle comprising a prime mover including an engine and a motor, and an engagement device such as a dog clutch.

### Discussion of the Related Art

JP-A-2009-222102 describes a control device for a hybrid vehicle in which a prime mover includes an engine, a first motor and a second motor. The hybrid vehicle to which the control device taught by JP-A-2009-222102 is applied comprises a power split mechanism (i.e., a differential mechanism) that distributes an output torque of the engine to the first motor and an output shaft. Specifically, the hybrid vehicle to which the control device taught by JP-A-2009-222102 is provided with two sets of the power split mechanisms, and in the power split mechanisms, a first rotary element is connected to the engine, a second rotary element is connected to the first motor, a third rotary element is connected to an output shaft, and a fourth rotary element is connected to a dog clutch. According to the teachings of JP-A-2009-222102, a continuously variable mode in which a speed of the engine is varied continuously may be established by disengaging the dog clutch while changing a speed of the first motor continuously, and a fixed mode in which a speed ratio of the power split mechanism is fixed to an overdrive ratio may be established by engaging the dog clutch while halting the fourth rotary element.

The control device taught by JP-A-2009-222102 is configured to prevent an interference between dog teeth of an input element of the dog clutch and dog teeth of an output element of the dog clutch when engaging the dog clutch. To this end, according to the teachings of JP-A-2009-222102, an actuator of the dog clutch is actuated in a direction to engage the dog teeth of the input element with the dog teeth of the output element, and then a torque of the first motor is applied to the input element alternately in the forward direction and the reverse direction to shift the phase of the dog teeth of the input element.

However, a predetermined backlash is maintained between each tooth of the input element and each tooth of the output element engaged with each other. Therefore, if one of the rotary elements of the dog clutch is rotated alternately in the forward direction and the reverse direction, the dog teeth of the engagement element thus rotated alternately are brought into contact repeatedly to the dog teeth of the other engagement element. Consequently, collision noise and engagement shock may be increased excessively.

### SUMMARY

Aspects of embodiments of the present disclosure have been conceived noting the foregoing technical problems, and it is therefore an object of the present disclosure to provide a control system for a hybrid vehicle configured to smoothly engage an engagement device while reducing a collision noise of the engagement device.

The control system according to the exemplary embodiment of the present disclosure is applied to a hybrid vehicle comprising: an engine; a motor having a generating function; a differential mechanism comprising an input element connected to the engine, a reaction element connected to the motor, and an output element connected to a pair of drive wheels; and an engagement device that selectively stops a rotation of an output shaft of the engine by mating a set of teeth on one half to a set of teeth on the other half. In order to achieve the above-explained objective, according to the exemplary embodiment of the present disclosure, the control system is provided with a controller that controls the motor and the engagement device. Specifically, the controller is configured to: start mating the set of teeth on one half of the engagement device to the set of teeth on the other half of the engagement device when the engagement device is required to be engaged; determine whether each tooth on one half of the engagement device is individually brought into contact to each tooth on the other half of the engagement device during engagement of the engagement device thereby causing an interference between the sets of teeth; apply a torque to the set of teeth on one half of the engagement device to shift a phase of the set of teeth on one half of the engagement device if the interference between the sets of teeth is caused; determine whether the engagement of the engagement device is completed; and further apply the torque to the set of teeth on one half of the engagement device in a same direction as the torque to shift the phase of the set of teeth on one half of the engagement device, so as to reduce backlash between the set of teeth on one half of the engagement device and the set of teeth on the other half of the engagement device, when the engagement of the engagement device is completed.

In a non-limiting embodiment, the controller may be further configured to maintain the torque to reduce the backlash between the sets of teeth for a predetermined period of time.

In a non-limiting embodiment, the controller may be further configured to: generate the torque to shift the phase of the set of teeth on one half of the engagement device and the torque to reduce backlash between the sets of teeth by changing an output torque of the motor; and set the torque to reduce backlash between the sets of teeth less than a maximum acceptable torque.

In a non-limiting embodiment, the controller may be further configured to change the torque of the motor gradually to shift the phase of the set of teeth on one half of the engagement device, and to reduce backlash between the sets of teeth.

In a non-limiting embodiment, the motor may serve as a first motor, and the hybrid vehicle may further comprise a second motor that is connected to the pair of drive wheels in a torque transmittable manner. The differential mechanism may include: a first planetary gear unit that performs a differential action among a first input element, a first reaction element, and a first output element; and a second planetary gear unit that performs a differential action among a second input element, a second reaction element, and a second output element. In the differential mechanism, the first input element may be connected to the engine, the first reaction element may be connected to the first motor, the first output element may be connected to the second input element, and the second output element may be connected to a member of the drive wheel side.

In a non-limiting embodiment, the motor may include a first motor and a second motor, and the differential mechanism may include a planetary gear unit that performs a differential action among a first input element, a first reaction element, a first output element, and a second reaction element. In the differential mechanism, the first input element may be connected to the engine, the first reaction element may be connected to the first motor, the second reaction element may be connected to the second motor, and the first output element may be connected to a member of the drive wheel side.

In a non-limiting embodiment, the controller may be further configured to generate the torque to shift the phase of the set of teeth on one half of the engagement device by at least one of the first motor and the second motor.

In a non-limiting embodiment, the controller may be further configured to generate the torque to reduce the backlash between the sets of teeth by at least one of the first motor and the second motor.

In a non-limiting embodiment, the controller may be further configured to bring the engagement device into engagement when both of the first motor and the second motor generate torques in a direction to propel the hybrid vehicle in the forward direction.

Thus, in the event of teeth interference in the engagement device, the control system according to the embodiment of the present disclosure changes the torque of at least one of the motors to shift the phase of the set of teeth on one half of the engagement device, so as to expedite engagement of the engagement device. In addition, after engaging the engagement device completely, the control system according to the embodiment of the present disclosure further changes the torque of at least one of the motors in the same direction to reduce the backlash between the sets of teeth of the engagement device. To this end, specifically, the torque of the motor is changed slightly in a mild manner. According to the embodiment of the present disclosure, therefore, the engagement may be engaged smoothly without generating a collision noise between the set of teeth.

In addition, since the engagement device is engaged while reducing the backlash, the set of teeth on one half of the engagement device will not collide against the set of teeth on the other half of the engagement device when an accelerator pedal is depressed after engaging the engagement device. According to the embodiment of the present disclosure, therefore, a noise and a shock may be reduced when accelerating the vehicle.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a skeleton diagram showing one example of a powertrain of a hybrid vehicle to which the control system according to embodiment of the present disclosure is applied;

FIG. 2 is a schematic illustration showing a structure of a brake B1;

FIG. 3 is a block diagram showing a structure of an electronic control unit;

FIG. 4 is a table showing engagement states of engagement devices and operating conditions of the prime movers in each operating mode;

FIG. 5 is a nomographic diagram showing a situation of the powertrain shown in FIG. 1 in a HV-High mode;

FIG. 6 is a nomographic diagram showing a situation in a HV-Low mode;

FIG. 7 is a nomographic diagram showing a situation of the powertrain shown in FIG. 1 in a fixed mode;

FIG. 8 is a nomographic diagram showing a situation of the powertrain shown in FIG. 1 in an EV-Low mode;

FIG. 9 is a nomographic diagram showing a situation of the powertrain shown in FIG. 1 in the EV-High mode;

FIG. 10 is a nomographic diagram showing a situation of the powertrain shown in FIG. 1 in a single-motor mode;

FIG. 11 is a flowchart showing one example of a routine executed by the control system according to the embodiment of the present disclosure;

FIG. 12 is a time chart indicating temporal changes in conditions of the hybrid vehicle during execution of the routine shown in FIG. 11;

FIG. 13 is a skeleton diagram showing another example of the powertrain of the hybrid vehicle to which the control system according to embodiment of the present disclosure is applied;

FIG. 14 is a nomographic diagram showing a situation of the powertrain shown in FIG. 13 in the EV mode;

FIG. 15 is a nomographic diagram showing a situation of the powertrain shown in FIG. 13 in the dual-motor mode;

FIG. 16 is a nomographic diagram showing a situation of the powertrain shown in FIG. 13 when starting the engine;

FIG. 17 is a nomographic diagram showing a situation of the powertrain shown in FIG. 13 in the HV mode;

FIG. 18 is a flowchart showing another example of a routine executed by the control system according to the embodiment of the present disclosure; and

FIG. 19 is a time chart indicating temporal changes in conditions of the hybrid vehicle during execution of the routine shown in FIG. 18.

### DETAILED DESCRIPTION OF THE PREFERRED EMBODIMENT(S)

Embodiments of the present disclosure will now be explained with reference to the accompanying drawings. Note that the embodiments shown below are merely examples of the present disclosure, and do not limit a scope of the present disclosure.

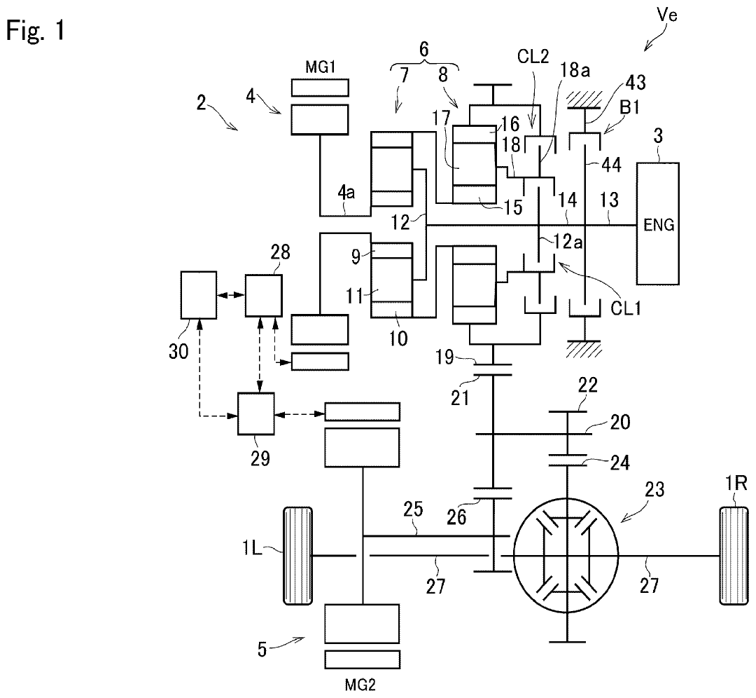

Referring now to FIG. 1, there is shown one example of a structure of a hybrid vehicle (as will be simply called the “vehicle” hereinafter) Ve to which the control system according to the embodiment is applied. Specifically, FIG. 1 shows a powertrain 2 of the vehicle Ve that drives a pair of front wheels 1R and 1L, and the powertrain 2 comprises an engine (referred to as “ENG” in the drawings) 3, a first motor (referred to as “MG1” in the drawings) 4, and a second motor (referred to as “MG2” in the drawings) 5. According to the exemplary embodiment, a motor-generator having a generating function is adopted as the first motor 4. In the vehicle Ve, a speed of the engine 3 is controlled by the first motor 4, and the second motor 5 is driven by electric power generated by the first motor 4 to generate a drive force for propelling the vehicle Ve. The motor-generator having a generating function may also be employed as the second motor 5.

A power split mechanism 6 as a differential mechanism is connected to the engine 3. The power split mechanism 6 includes a power split section 7 that distributes an output torque of the engine 3 to the first motor 4 side and to an output side, and a transmission section 8 that alters a torque split ratio.

For example, a single-pinion planetary gear unit adapted to perform differential action among three rotary elements may be used as the power split section 7. That is, the power split section 7 serves as a first planetary gear unit of the embodiment. Specifically, the power split section 7 comprises: a sun gear 9; a ring gear 10 as an internal gear arranged concentrically with the sun gear 9; a plurality of pinion gears 11 interposed between the sun gear 9 and the ring gear 10 while being meshed with both gears 9 and 10; and a carrier 12 supporting the pinion gears 11 in a rotatable manner. In the power split section 7, accordingly, the sun gear 9 serves mainly as a first reaction element, the ring gear 10 serves mainly as a first output element, and the carrier 12 serves mainly as a first input element.

An output shaft 13 of the engine 3 is connected to an input shaft 14 of the power split mechanism 6 connected to the carrier 12 so that output power of the engine 3 is applied to the carrier 12. Optionally, an additional gear unit may be interposed between the input shaft 14 and the carrier 12, and a damper device and a torque converter may be interposed between the output shaft 13 and the input shaft 14.

The sun gear 9 is connected to the first motor 4. In the embodiment shown in FIG. 1, the power split section 7 and the first motor 4 are arranged concentrically with a rotational center axis of the engine 3, and the first motor 4 is situated on an opposite side of the engine 3 across the power split section 7. The transmission section 8 as a second planetary gear unit is interposed coaxially between the power split section 7 and the engine 3.

Specifically, the transmission section 8 is a single-pinion planetary gear unit comprising: a sun gear 15; a ring gear 16 as an internal gear arranged concentrically with the sun gear 15; plurality of pinion gears 17 interposed between the sun gear 15 and the ring gear 16 while being meshed with both gears 17 and 18; and a carrier 18 supporting the pinion gears 17 in a rotatable manner. Thus, the transmission section 8 is also adapted to perform a differential action among the sun gear 15, the ring gear 16, and the carrier 18. In the transmission section 8, the sun gear 15 is connected to the ring gear 10 of the power split section 7, and the ring gear 16 is connected to an output gear 19. Accordingly, the sun gear 15 serves as a second reaction element, the carrier 18 serves as a second input element, and the ring gear 16 serves as a second output element.

In order to use the power split section 7 and the transmission section 8 as a complex planetary gear unit, a first clutch CL1 is disposed to selectively connect the carrier 18 of the transmission section 8 to the carrier 12 of the power split section 7. Specifically, a rotary disc 12a is fitted onto the input shaft 14, and the first clutch CL1 engages the rotary disc 12a selectively with the carrier 18 of the transmission section 8. For example, a wet-type multiple plate clutch or a dog clutch may be adopted as the first clutch CL1. Otherwise, a normally stay clutch may also be employed as the first clutch CL1. An engagement state of the normally stay clutch is switched upon reception of the command signal, and the normally stay clutch stays in the current engagement state even if the signal transmission thereto is interrupted. Thus, in the powertrain 2 shown in FIG. 1, the power split section 7 is connected to the transmission section 8 to serve as a complex planetary gear unit by engaging the first clutch CL1. In the complex planetary gear unit thus formed, the carrier 12 of the power split section 7 is connected to the carrier 18 of the transmission section 8 to serve as an input element, the sun gear 9 of the power split section 7 serves as a reaction element, and the ring gear 16 of the transmission section 8 serves as an output element. That is, the complex planetary gear unit is configured such that the input shaft 14, the output shaft 4a of the first motor 4, and the driven gear 21 are allowed to rotate in a differential manner.

A second clutch CL2 is disposed to rotate the rotary elements of the transmission section 8 integrally. For example, a friction clutch, a dog clutch and a normally stay clutch may also be used as the second clutch CL2 to selectively connect the carrier 18 to the ring gear 16 or the sun gear 15, or to connect the sun gear 15 to the ring gear 16. In the powertrain 2 shown in FIG. 1, specifically, the second clutch CL2 is adapted to connect the carrier 18 to the ring gear 16 to rotate the rotary elements of the transmission section 8 integrally. Specifically, a rotary disc 18a is provided to be rotated integrally with the carrier 18, and the second clutch CL2 engages the rotary disc 18a selectively with the ring gear 16 of the transmission section 8.

The first clutch CL1 and the second clutch CL2 are arranged coaxially with the engine 3, the power split section 7, and the transmission section 8 on the opposite side of the power split section 7 across the transmission section 8. The first clutch CL1 and the second clutch CL2 may be arranged not only in parallel to each other in a radial direction but also in tandem in an axial direction. In the powertrain 2 shown in FIG. 1, the first clutch CL1 and the second clutch CL2 are arranged radially parallel to each other and hence an axial length of the powertrain can be shortened. In addition, since a width of the powertrain will not be widened by the clutches CL1 and CL2, number of friction plates of the frictional clutch can be reduced.

A counter shaft 20 extends parallel to a common rotational axis of the engine 3, the power split section 7, and the transmission section 8. A driven gear 21 is fitted onto one end of the counter shaft 20 to be meshed with the output gear 19, and a drive gear 22 is fitted onto the other end of the counter shaft 20 to be meshed with a ring gear 24 of a differential gear unit 23 as a final reduction. The driven gear 21 is also meshed with a drive gear 26 fitted onto a rotor shaft 25 of the second motor 5 so that power or torque of the second motor 5 is synthesized with power or torque of the output gear 19 at the driven gear 21 to be distributed from the differential gear unit 23 to the front wheels 1R and 1L via each driveshaft 27.

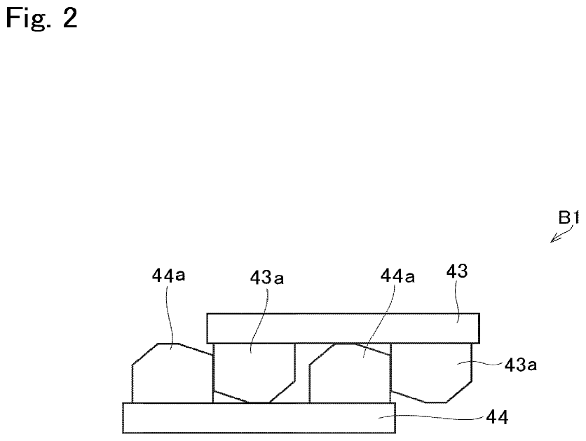

In order to selectively stop a rotation of the output shaft 13 or the input shaft 14 for the purpose of delivering the drive torque generated by the first motor 4 to the front wheels 1R and 1L, a brake B1 is arranged in the powertrain 2. Specifically, the carrier 12 of the power split section 7 and the carrier 18 of the transmission section 8 are allowed to serve as reaction elements, and the sun gear 9 of the power split section 7 is allowed to serve as an input element by applying the brake B1 to halt the output shaft 13 or the input shaft 14. To this end, the brake B1 may be adapted to stop the rotation of the output shaft 13 or the input shaft 14 not only completely but also incompletely to apply a reaction torque to those shafts. For example, a conventional dog brake having dog teeth each of which has a rectangular or trapezoidal cross-section may be adopted as the brake B1. Specifically, the dog teeth of one of engagement elements of the brake B1 is pushed by an actuator to be engaged with the dog teeth of other one of engagement elements of the brake B1. One example of the brake B1 shown in FIG. 2 comprises a stationary member 43 fixed to a part of the powertrain, e.g. a transmission case (not shown), and a rotary member 44 rotated integrally with the output shaft 13. The stationary member 43 has dog teeth 43a on its face opposed to the rotary member 44 while keeping predetermined intervals in a rotational direction of the rotary member 44 (i.e. lateral direction in FIG. 2). The rotary member 44 has dog teeth 44a on its face opposed to the stationary member 43 to be engaged with the dog teeth 43a of the stationary member 43, while keeping predetermined intervals in the rotational direction of the rotary member 44. That is, the stationary member 43 and the rotary member 44 are located coaxially, and the dog teeth 43a and 44a transmit a torque by being engaged with each other. In the example shown in FIG. 2, the stationary member 43 and the rotary member 44 of the brake B1 serve as one half and the other half of an engagement device, respectively. Further, the dog teeth 43a of stationary member 43 and the dog teeth 44a of the rotary member 44 of the brake B1 serve as a set of teeth on the one half and a set of teeth on the other half of the engagement device, respectively.

A first power control system 28 is connected to the first motor 4, and a second power control system 29 is connected to the second motor 5. Each of the first power control system 28 and the second power control system 29 individually includes an inverter and a converter. The first power control system 28 and the second power control system 29 are connected to each other, and also connected individually to an electric storage device 30 including a lithium ion battery, a capacitor, and a solid-state battery. For example, when the first motor 4 is operated as a generator while establishing a reaction torque, an electric power generated by the first motor 4 may be supplied directly to the second motor 5 without passing through the electric storage device 30.

Characteristics of the lithium ion battery, the capacitor, and the solid-state battery adopted as the electric storage device 30 are different from one another. The electric storage device 30 may be formed by combining those storage devices arbitrarily according to need.

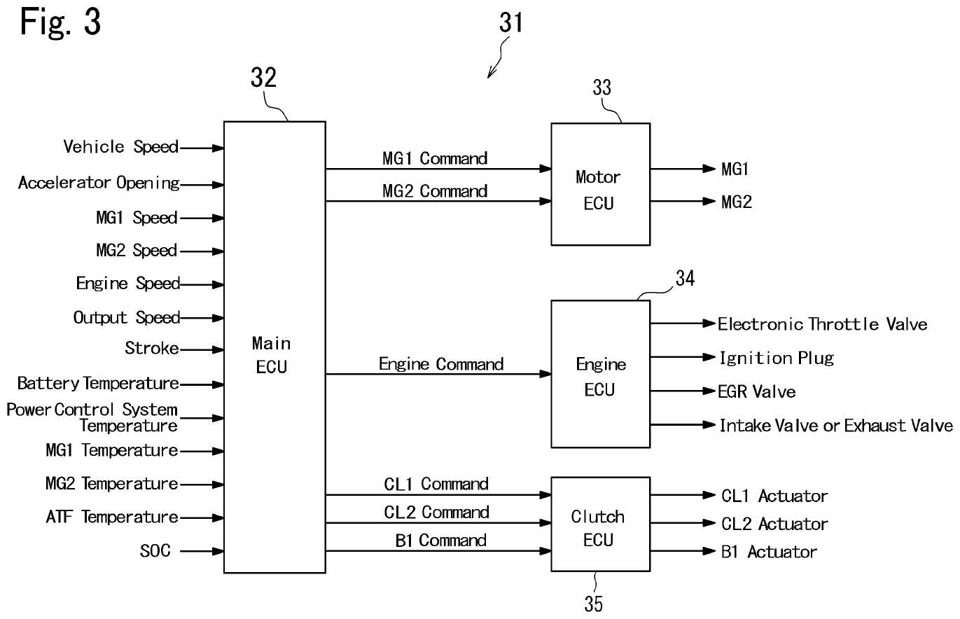

In order to control the first power control system 28, the second power control system 29, the first clutch CL1, the second clutch CL2, the brake B1 and so on, the vehicle Ve is provided with an electronic control unit (to be abbreviated as the “ECU” hereinafter) 31 as a controller. The ECU 31 has a microcomputer as its main constituent, and as shown in FIG. 3, the ECU 31 comprises a main ECU 32, a motor ECU 33, an engine ECU 34 and a clutch ECU 35.

The main ECU 32 is configured to execute a calculation based on incident data transmitted from sensors as well as maps and formulas installed in advance, and transmits a calculation result to the motor ECU 33, the engine ECU 34 and the clutch ECU 35 in the form of command signal. For example, the main ECU 32 receives data about; a vehicle speed; an accelerator position; a speed of the first motor 4; a speed of the second motor 5; a speed of the output shaft 13 of the engine 3; an output speed such as a speed of the counter shaft 20 of the transmission section 8; strokes of pistons of the clutches CL1, CL2, and the brake B1; a temperature of the electric storage device 30; temperatures of the power control systems 30, 31; a temperature of the first motor 4; a temperature of the second motor 5; a temperature of oil (i.e., ATF) lubricating the power split section 7 and the transmission section 8; a state of charge (to be abbreviated as the “SOC” hereinafter) level of the electric storage device 30 and so on.

Specifically, command signals of output torques and speeds of the first motor 4, the second motor 5 are transmitted from the main ECU 32 to the motor ECU 33. Likewise, command signals of an output torque and a speed of the engine 3 are transmitted from the main ECU 32 to the engine ECU 34, and command signals of torque transmitting capacities (including “0”) of the clutches CL1, CL2, and the brakes B1 are transmitted from the main ECU 32 to the clutch ECU 35.

The motor ECU 33 calculates current values applied to the first motor 4 and the second motor 5 based on the data transmitted from the main ECU 32, and transmits calculation results to the motors 4, 5 in the form of command signals. In the vehicle Ve, an AC motor is used as the first motor 4 and the second motor 5 respectively. In order to control the AC motor, the command signal transmitted from the motor ECU 33 includes command signals for controlling a frequency of a current generated by the inverter and a voltage value boosted by the converter.

The engine ECU 34 calculates current values to control opening degrees of an electronic throttle valve, an EGR (Exhaust Gas Restriction) valve, an intake valve, an exhaust valve, and an exhaust valve, and to activate an ignition plug, based on the data transmitted from the main ECU 32. Calculation results are transmitted from the engine ECU 34 to the valves and the plug in the form of command signals. Thus, the engine ECU 34 transmits command signals for controlling a power, an output torque and a speed of the engine 3.

The clutch ECU 35 calculates current values supplied to actuators controlling engagement pressures of the clutches CL1, CL2, and the brake B1 based on the data transmitted from the main ECU 32, and transmits calculation results to the actuators in the form of command signals.

In the vehicle Ve, an operating mode may be selected from a hybrid mode (to be abbreviated as the “HV mode” hereinafter) in which the vehicle Ve is propelled by a drive torque generated by the engine 3, and an electric vehicle mode (to be abbreviated as the “EV mode” hereinafter) in which the vehicle Ve is propelled by drive torques generated by the first motor 4 and the second motor 5 without using the engine 3. The HV mode may be selected from a hybrid-low mode (to be abbreviated as the “HV-Low mode” hereinafter), a hybrid-high mode (to be abbreviated as the “HV-High mode” hereinafter), and a fixed mode. Specifically, in the HV-Low mode, a rotational speed of the engine 3 (i.e., a rotational speed of the input shaft 14) is increased higher than a rotational speed of the ring gear 16 of the transmission section 8 when a rotational speed of the first motor 4 is reduced to substantially zero. In turn, in the HV-High mode, a rotational speed of the engine 3 is reduced lower than a rotational speed of the ring gear 16 of the transmission section 8 when a rotational speed of the first motor 4 is reduced to substantially zero. Further, in the fixed mode, the engine 3 and the ring gear 16 of the transmission section 8 are always rotated at substantially same speeds.

The EV mode may be selected from a dual-motor mode in which both of the first motor 4 and the second motor 5 generate drive torques to propel the vehicle Ve, and a single-motor mode in which only the second motor 5 generates a drive torque to propel the vehicle Ve. Further, the dual-motor mode may be selected from an electric vehicle-low mode (to be abbreviated as the “EV-Low mode” hereinafter) in which a torque of the first motor 4 is multiplied by a relatively larger factor, and an electric vehicle-high mode (to be abbreviated as the “EV-High mode” hereinafter) in which a torque of the first motor 4 is multiplied by a relatively smaller factor. In the single-motor mode, the vehicle Ve is powered only by the second motor 5, while engaging the first clutch CL1, while engaging the second clutch CL2, or while disengaging both of the first clutch CL1 and the second clutch CL2.

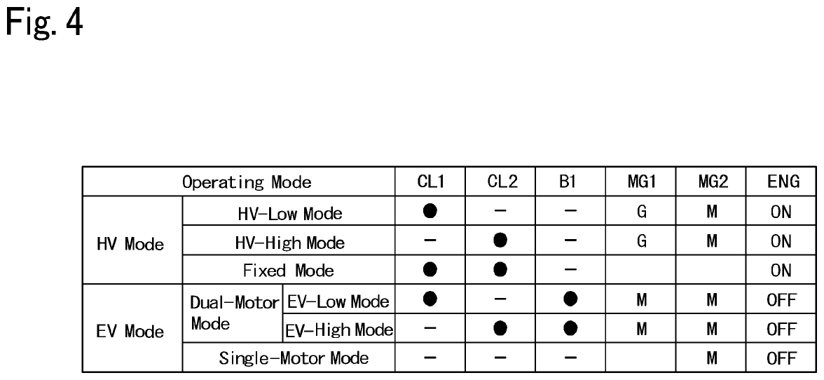

FIG. 4 shows engagement states of the first clutch CL1, the second clutch CL2, and the brake B1, and operating conditions of the first motor 4, the second motor 5, and the engine 3 in each operating mode. In FIG. 4, “●” represents that the engagement device is in engagement, “−” represents that the engagement device is in disengagement, “G” represents that the motor serves mainly as a generator, “M” represents that the motor serves mainly as a motor, blank represents that the motor serves as neither a motor nor a generator or that the motor is not involved in propulsion of the vehicle Ve, “ON” represents that the engine 3 generates a drive torque, and “OFF” represents that the engine 3 does not generate a drive torque.

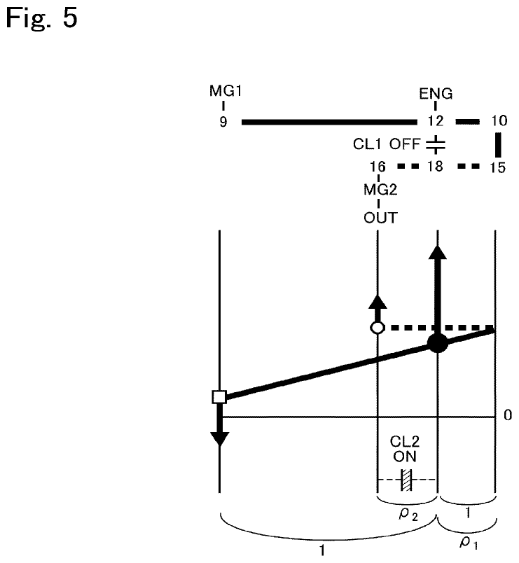

Rotational speeds of the rotary elements of the power split mechanism 6, and directions of torques of the engine 3, the first motor 4, and the second motor 5 in each operating mode are indicated in FIGS. 5 to 10. In the nomographic diagrams shown in FIGS. 5 to 10, distances among the vertical lines represents a gear ratio of the power split mechanism 6, a vertical distance on the vertical line from the horizontal base line represents a rotational speed of the rotary member, an orientation of the arrow represents a direction of the torque, and a length of the arrow represents a magnitude of the torque.

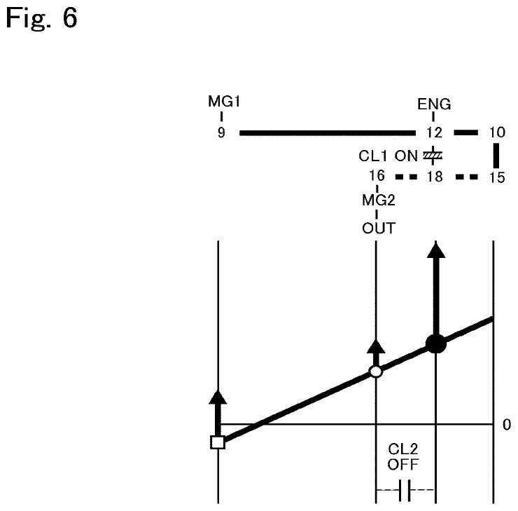

As indicated in FIG. 5, in the HV-High mode, the second clutch CL2 is engaged, and the engine 3 generates a drive torque while establishing a reaction torque by the first motor 4. As indicated in FIG. 6, in the HV-Low mode, the first clutch CL1 is engaged, and the engine 3 generates a drive torque while establishing a reaction torque by the first motor 4. In the HV-High mode and the HV-Low mode, a rotational speed of the first motor 4 is controlled in such a manner as to optimize a total energy efficiency in the powertrain 2 including a fuel efficiency of the engine 3 and a driving efficiency of the first motor 4. Specifically, the total energy efficiency in the powertrain 2 may be calculated by dividing a total energy consumption by a power to rotate the front wheels 1R and 1L. A rotational speed of the first motor 4 may be varied continuously, and the rotational speed of the engine 3 is governed by the rotational speed of the first motor 4 and a vehicle speed. That is, the power split mechanism 6 may serve as a continuously variable transmission.

As a result of establishing a reaction torque by the first motor 4, the first motor 4 may serve as a generator. In this situation, therefore, a power of the engine 3 is partially translated into an electric energy, and the remaining power of the engine 3 is delivered to the ring gear 16 of the transmission section 8. Specifically, the reaction torque established by the first motor 4 is governed by a split ratio of the torque delivered from the engine 3 to the first motor 4 side through the power split mechanism 6. Such split ratio between the torque delivered from the engine 3 to the first motor 4 side through the power split mechanism 6 and the torque delivered from the engine 3 to the ring gear 16 differs between the HV-Low mode and the HV-High mode.

Given that the torque delivered to the first motor 4 side is “1”, a ratio of the torque applied to the ring gear 16 in the HV-Low mode may be expressed as “1/(ρ1·ρ2)”, and a ratio of the torque applied to the ring gear 16 in the HV-High mode may be expressed as “1/(ρ1)”. In other words, given that the torque of the engine 3 is “1”, a ratio of the torque of the engine 3 delivered to the ring gear 16 in the HV-Low mode may be expressed as “1/(1−(ρ1·ρ2))”, and a ratio of the torque of the engine 3 delivered to the ring gear 16 in the HV-High mode may be expressed as “1/(ρ1+1)”. In the above expressions, “ρ1” is a gear ratio of the power split section 7 (i.e., a ratio between teeth number of the ring gear 10 and teeth number of the sun gear 9), and “ρ2” is a gear ratio of the transmission section 8 (i.e., a ratio between teeth number of the ring gear 16 and teeth number of the sun gear 15). Specifically, “ρ1” and “ρ2” are smaller than “1”, respectively. That is, in the HV-Low mode, a ratio of the torque delivered to the ring gear 16 is increased in comparison with that in the HV-High mode.

Here, when the speed of the engine 3 is increased by the torque generated by the engine 3, the output torque of the engine 3 may be calculated by subtracting a torque required to increase the speed of the engine 3 from the torque generated by the engine 3. In the HV mode, the electric power generated by the first motor 4 is supplied to the second motor 5, and in addition, the electric power accumulated in the electric storage device 30 is also supplied to the second motor 5 as necessary.

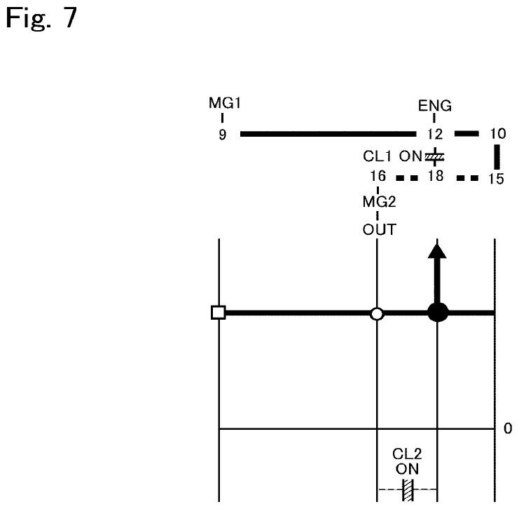

In the fixed mode, as indicated in FIG. 7, both of the first clutch CL1 and the second clutch CL2 are engaged so that all of the rotary elements in the power split mechanism 6 are rotated at same speeds. In other words, the output power of the engine 3 will not be translated into an electric energy by the first motor 4 and the second motor 5. For this reason, a power loss associated with such energy conversion will not be caused in the fixed mode and hence power transmission efficiency can be improved.

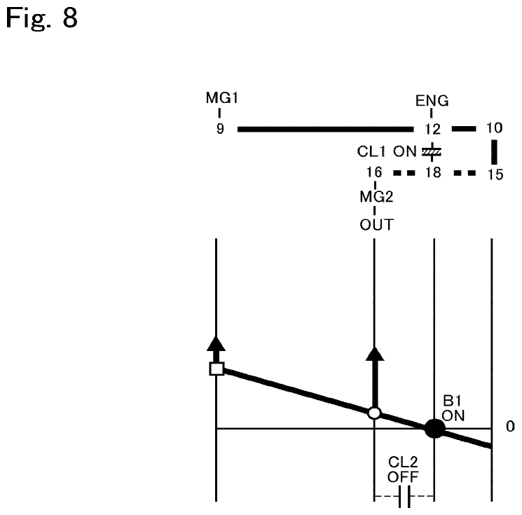

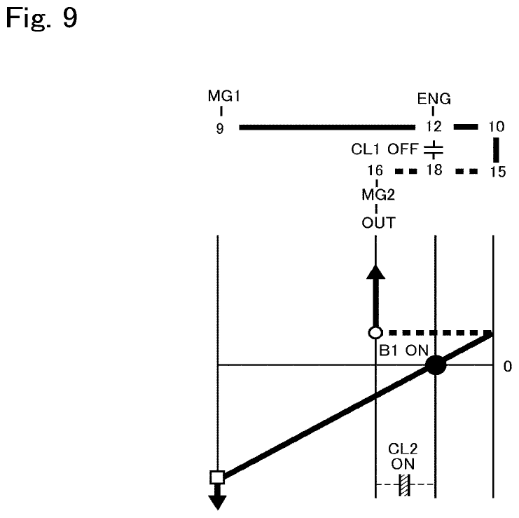

As indicated in FIGS. 8 and 9, in the EV-Low mode and the EV-High mode, the brake B1 is engaged, and the first motor 4 and the second motor 5 generates the drive torques to propel the vehicle Ve. As indicated in FIG. 8, in the EV-Low mode, the vehicle Ve is propelled by the drive torques generated by the first motor 4 and the second motor 5 while engaging the brake B1 and the first clutch CL1. In this case, the brake B1 establishes a reaction torque to restrict a rotation of the output shaft 13 or the carrier 12. In the EV-Low mode, the first motor 4 is rotated in the forward direction while generating torque in a direction to increase a rotational speed. As indicated in FIG. 9, in the EV-High mode, the vehicle Ve is propelled by drive torques generated by the first motor 4 and the second motor 5 while engaging the brake B1 and the second clutch CL2. In this case, the brake B1 also establishes a reaction torque to restrict a rotation of the output shaft 13 or the carrier 12. In the EV-High mode, the first motor 4 is rotated in the opposite direction (i.e., in a reverse direction) to the rotational direction of the engine 3 in the HV mode, while generating torque in a direction to increase a rotational speed.

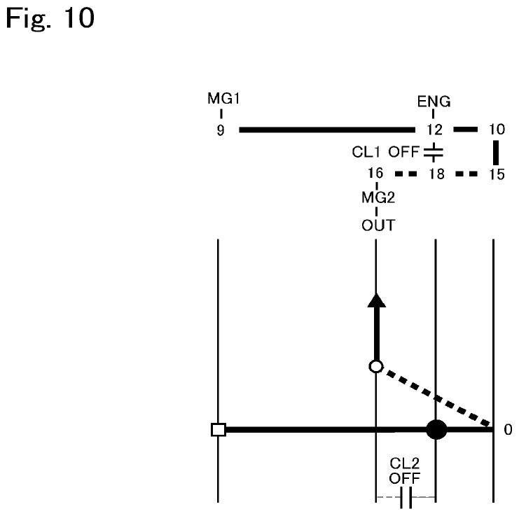

In the EV-Low mode, a ratio of a rotational speed of the ring gear 16 of the transmission section 8 to a rotational speed of the first motor 4 is reduced smaller than that in the EV-High mode. That is, in the EV-Low mode, the rotational speed of the first motor 4 at a predetermined speed is increased higher than that in the EV-High mode. In other words, a speed reducing ratio in the EV-Low mode is greater than that in the EV-High mode. In the EV-Low mode, therefore, a larger drive force may be generated. Here, in the powertrain 2 shown in FIG. 1, the rotational speed of the ring gear 16 corresponds to a rotational speed of an output member, and the following explanation will be made on the assumption that a gear ratio among each member from the ring gear 16 to the front wheels 1R and 1L is “1” for the sake of convenience. As indicated in FIG. 10, in the single-motor mode, only the second motor 5 generates a drive torque, and both of the first clutch CL1 and the second clutch CL2 are disengaged. In the single-motor mode, therefore, all of the rotary elements of the power split mechanism 6 are stopped. For this reason, the engine 3 and the first motor 4 will not be rotated passively, and hence the power loss can be reduced.

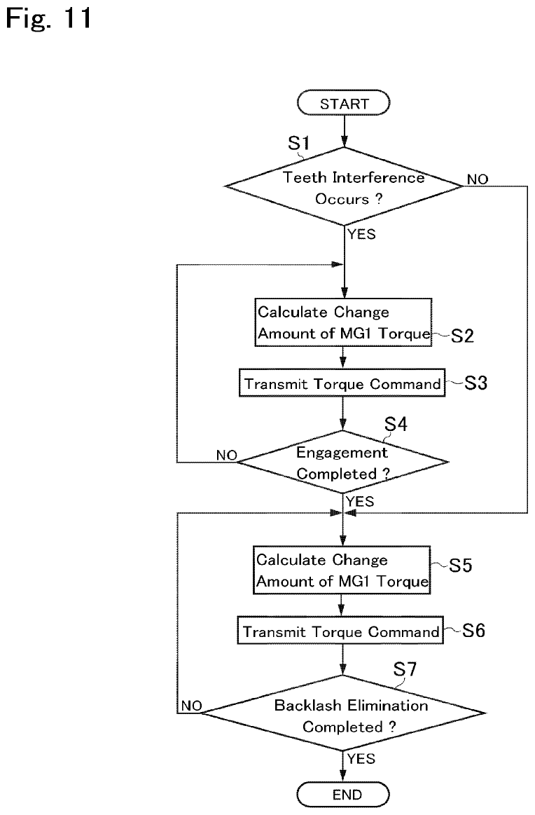

During propulsion in the single-motor mode, the operating mode may be shift from the single-motor mode to the EV-High mode or to the EV-Low mode of the dual-motor mode by engaging the brake B1. In those cases, the brake B1 establishes a reaction torque to stop a rotation of the output shaft 13 or the carrier 12. As described, the brake B1 is brought into engagement by mating a set of teeth on one half of the brake B1 to a set of teeth on the other half of the brake B1. Therefore, if a top land of each tooth on one half of the brake B1 is individually brought into contact to a top land of each tooth on the other half of the brake B1, the brake B1 may not be engaged completely. In this situation, if the brake B1 is engaged compulsory by further pushing said one half of the brake B1, loud noise may be generated by collision impact between those sets of teeth. In addition, each set of teeth of the brake B1 is regularly spaced and backlash remains inevitably between those sets of teeth even if the brake B1 is engaged completely. Therefore, if one of the sets of the teeth is rotated abruptly to achieve a required drive force, loud noise may also be generated by collision impact between those sets of teeth. In order to engage the brake B1 certainly and to reduce such collision noise, the ECU 31 is configured to execute a routine shown in FIG. 11.

The routine shown in FIG. 11 is commenced when an engaging operation of the brake B1 is started. At step S1, it is determined whether the top land of each tooth on one half of the brake B1 is individually brought into contact to the top land of each tooth on the other half of the brake B1. In other words, it is determined whether a teeth interference is caused in the brake B1. For example, if the set of teeth on one half of the brake B1 is out of phase with the set of teeth on the other half of the brake B1, the top land of each tooth on one half of the brake B1 is individually brought into contact to the top land of each tooth on the other half of the brake B1. In this situation, said one half of the brake B1 may not be moved toward the other half of the brake B1 and hence the brake B1 may not be engaged completely. Otherwise, if a face of each tooth on one half of the brake B1 is individually brought into contact to a face of each tooth on the other half of the brake B1, said one half of the brake B1 may also not be moved toward the other half of the brake B1. For example, such determination at step S1 may be made based on a stroke of the set of teeth on one half of the brake B1 detected by a stroke sensor.

If the teeth interference is caused in the brake B1 so that the answer of step S1 is YES, the routine progresses to step S2 to calculate a change amount of torque of the first motor 4 to shift the phase of e.g., the set of teeth on one half of the brake B1. In other words, the routine progresses to step S2 to calculate a torque of the first motor 4 to rotate said one half of the brake B1 so as to mate the set of teeth on one half of the brake B1 to the set of teeth on the other half of the brake B1. To this end, the change amount of the torque of the first motor 4 may be calculated with reference to a predetermined map, or based on a friction coefficient of the top land or the face of the tooth and an angle of inclination of the face of the tooth.

Then, at step S3, a torque command to the first motor 4 is calculated by adding or subtracting the change amount of the torque of the first motor 4 calculated at step S2 to/from a required torque of the first motor 4, and the torque command thus calculated is transmitted from the main ECU 32 to the motor ECU 33. Here, it is to be noted that the set of teeth on one half of the brake B1 may be rotated in either direction to be mated to the set of teeth on the other half of the brake B1. For example, in a case of shifting the operating mode to the EV-High mode, it is preferable to generate a torque of the first motor 4 in a reverse direction. In addition, in order to reduce an engagement shock of the brake B1, it is preferable to change the torque of the first motor 4 gradually.

Then, it is determined at step S4 whether the engaging operation of the brake B1 is completed. At step S4, specifically, it is determined at step S4 whether the set of teeth on one half of the brake B1 is mated completely to the set of teeth on the other half of the brake B1. Such determination at step S4 may also be made based on a stroke of the set of teeth on one half of the brake B1 detected by the stroke sensor. If the engaging operation of the brake B1 has not yet been completed so that the answer of step S4 is NO, the routine returns to step S2.

By contrast, if the engaging operation of the brake B1 has already been completed so that the answer of step S4 is YES, the routine progresses to step S5 to calculate a change amount of a torque of the first motor 4 to eliminate the backlash between the teeth on one half of the brake B1 and the teeth on the other half of the brake B1.

Specifically, such torque to reduce or eliminate the backlash is set to be less than a maximum acceptable torque possible to reduce the backlash without generating a rattling noise. In order to reduce the rattling noise in the brake B1, it is preferable to change the torque of the first motor 4 gradually. Then, at step S6, a torque command to the first motor 4 is calculated by adding or subtracting the change amount of the torque of the first motor 4 calculated at step S5 to a required torque of the first motor 4, and the torque command thus calculated is transmitted from the main ECU 32 to the motor ECU 33.

In order to eliminate the backlash in the brake B1, it is preferable to generate the torque of the first motor 4 in the same direction as the torque of the first motor 4 to shift the phase of the set of teeth on one half of the brake B1. Specifically, in the case of shifting the operating mode to the EV-High mode, it is preferable to generate the torque of the first motor 4 also in the reverse direction to reduce a required time to shift the operating mode to the EV-High mode while eliminating the backlash in the brake B1. Here, it is to be noted that backlashes in other engagement elements in the powertrain 2 to which the torque of the first motor 4 is applied may also be reduced by generating the torque by the first motor 4 based on the torque command calculated at step S5.

Thereafter, it is determined at step S7 whether the backlash eliminating operation of the brake B1 is completed. If the backlash in the brake B1 has not yet been eliminated so that the answer of step S7 is NO, the routine returns to step S5. By contrast, if the backlash in the brake B1 has already been eliminated so that the answer of step S7 is YES, the routine terminates. In this case, the torque of the first motor 4 to eliminate the backlash may be maintained for a predetermined period of time.

If the top lands of the teeth on one half of the brake B1 are not contacted to the top lands of the teeth on the other half of the brake B1 so that the answer of step S1 is NO, this means that the brake B1 is completely brought into engagement. In this case, therefore, the routine progresses to step S5 to execute steps S5 to S7 sequentially.

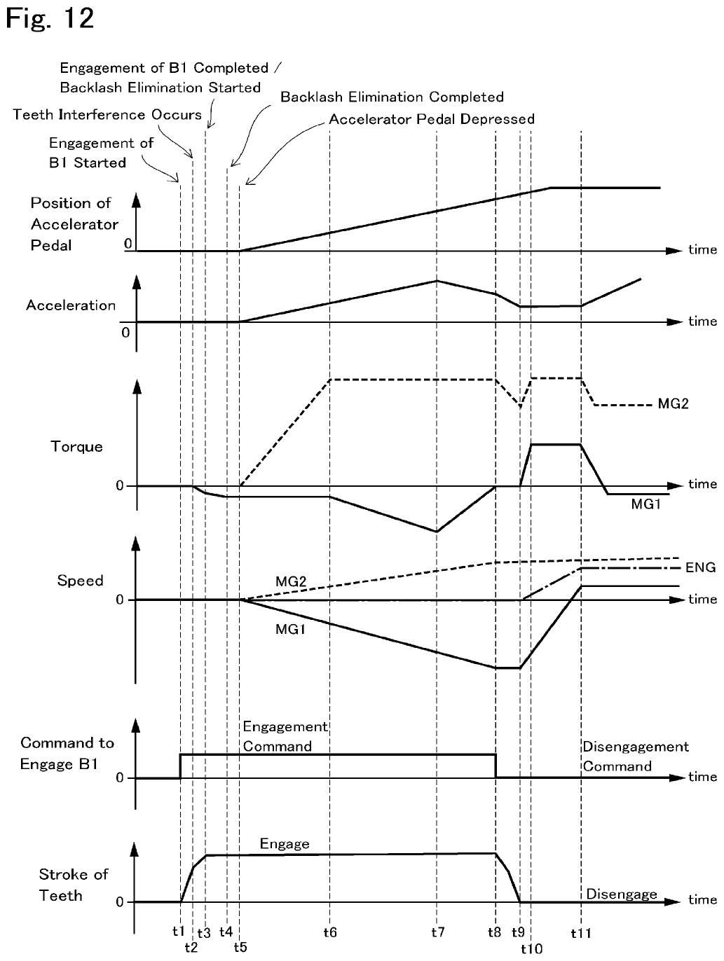

Next, a temporal change in situation of the vehicle Ve during execution of the routine shown in FIG. 11 will be explained with reference to FIG. 12. Specifically, FIG. 12 shows an example of launching the vehicle Ve stopped while disengaging the brake B1 in the dual-motor mode, and thereafter shifting the operating mode to the HV mode by starting the engine 3. In the example shown in FIG. 12, the engaging operation and the backlash eliminating operation of the brake B1 are executed before the accelerator pedal is depressed for the preparation of shifting the operating mode to the dual-motor mode to launch the vehicle Ve.

At point t1, the command signal to engage the brake B1 is transmitted from the main ECU 32 to the clutch ECU 35 so that the set of teeth on one half of the brake B1 starts moving toward the set of teeth on the other half of the brake B1. For example, the command signal to engage the brake B1 may be transmitted when an ignition switch is turned on.

At point t2, the top land of each tooth on one half of the brake B1 is individually comes into contact to the top land of each tooth on the other half of the brake B1. At point t3, therefore, the first motor 4 generates a torque in the reverse direction to shift the phase of the set of teeth on one half of the brake B1 so that the set of teeth on one half of the brake B1 is mated completely to the set of teeth on the other half of the brake B1. Consequently, a stroke of the set of teeth on one half of the brake B1 reaches the maximum value. In this situation, the backlash eliminating operation of the brake B1 is commenced. Specifically, the torque of the first motor 4 is further increased from point t3 gradually in the reverse direction until the backlash in the brake B1 is eliminated. Such backlash eliminating operation of the brake B1 is completed at point t4, and the negative torque of the first motor 4 is maintained for a predetermined period of time in order not to increase the backlash in the brake B1.

At point t5, the accelerator pedal is depressed by the driver so that the vehicle Ve is launched. In this situation, the vehicle Ve is propelled by a drive torque (i.e., a positive torque) generated by the second motor 5. An acceleration of the vehicle Ve and the torque of the second motor 5 are increased with an increase in depression of the accelerator pedal, and the torque of the second motor 5 reaches an upper limit at point t6. Consequently, the torque of the first motor 4 is increased in the reverse direction from point t6 to assist the torque of the second motor 5. In this situation, the first clutch CL1 is engaged if the vehicle Ve is propelled in the EV-Low mode, and the second clutch CL2 is engaged if the vehicle Ve is propelled in the EV-High mode.

The accelerator pedal is further depressed, and at point t7, a required drive force to propel the vehicle Ve exceeds an upper limit drive force possible to be generated in the EV mode. In this situation, therefore, a command signal to start the engine 3 is transmitted at point t7 from the main ECU 32 to the engine ECU 34.

Consequently, in order to shift the operating mode to the HV mode, the torque of the first motor 4 in the reverse direction is reduced toward zero from point t7 thereby reducing a load applied to the brake B1. When the load applied to the brake B1 is reduced to zero at point t8, a command to disengage the brake B1 is transmitted from the main ECU 32 to the clutch ECU 35 so that the set of teeth on one half of the brake B1 is withdrawn from the set of teeth on the other half of the brake B1. Thereafter, when the brake B is disengaged completely at point t9, the first motor 4 generates torque in the forward direction to crank the engine 3. Consequently, a speed of the engine 3 is increased to a target speed from point t9 to point t11, and the operating mode of the vehicle Ve is shifted from the EV mode to the HV mode.

Here, when cranking the engine 3 by the first motor 4, the first motor 4 generates the torque in the forward direction and hence the driving force may be reduced temporarily during cranking the engine 3. In order to prevent such reduction in the drive force, the torque of the second motor 5 is reduced temporarily from point t8, and increased from point t9 during cranking the engine 3. The acceleration of the vehicle Ve being increased with an increase in depression of the accelerator pedal is reduced temporarily from point t7 at which the command signal to start the engine 3 is transmitted, and increased again from point t11 at which the speed of the engine 3 is increased to the target speed.

Thus, the engaging operation and the backlash eliminating operation of the brake B1 shown in FIG. 11 are suitable to launch the vehicle Ve in the EV mode. Therefore, it is preferable to execute the engaging operation and the backlash eliminating operation of the brake B1 if e.g., a switch to select an economy mode is turned on when launching the vehicle Ve, or if data indicates that the driver prefers to operate the vehicle Ve in the EV mode.

Thus, in the event of teeth interference of brake B1, the phase of the set of teeth on one half of the brake B1 is shifted by the torque of the first motor 4. According to the embodiment of the present disclosure, therefore, the brake B1 is allowed to be brought into engagement smoothly while preventing an occurrence of tooth skip. In addition, the backlash in the brake B1 is also eliminated by adjusting the torque of the first motor 4 before shifting the operating mode to the dual-motor mode. According to the embodiment of the present disclosure, therefore, the set of teeth on one half of the brake B1 will not collide against the set of teeth on the other half of the brake B1. For this reason, collision noise in the brake B1 may be reduced when shifting the operating mode to the dual-motor mode. Specifically, the first motor 4 generates torque in the same direction to shift the phase of the set of teeth on one half of the brake B1, and to eliminate the backlash n the brake B1. For this reason, the backlash of the brake B1 may be eliminated without generating shocks. Further, since the brake B1 can be engaged before launching the vehicle Ve, a required drive force can be generated promptly in the dual-motor mode in response to an operation of the accelerator pedal when launching the vehicle Ve.

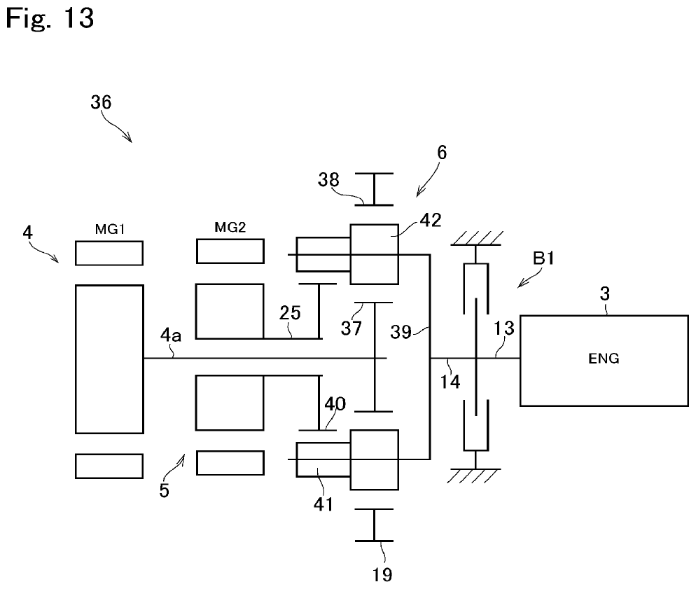

The control system according to the embodiment of the present disclosure may also be applied to a vehicle in which a Ravigneaux planetary gear unit is employed as the differential mechanism instead of the complex planetary gear unit comprising two sets of single pinion planetary gear units. Turning to FIG. 13, there is shown another example of the powertrain of the vehicle Ve. In FIG. 13, common reference numerals are allotted to the elements in common with those of the example shown in FIG. 1, and detailed explanation for the common elements will be omitted.

In the powertrain 36 shown in FIG. 13, the prime mover also includes the engine 3, the first motor 4, and the second motor 5. As described, in the powertrain 36, a Ravigneaux planetary gear unit is employed as the power split mechanism 6 (i.e., the differential mechanism). The power split mechanism 6 comprises a first sun gear 37, a ring gear 38, a carrier 39, and a second sun gear 40. A short pinion gear 41 meshed with the second sun gear 40, and a long pinion gear 42 meshed with the ring gear 38 and the first sun gear 37 are supported by the carrier 39 in a rotatable manner. The first sun gear 37 and the second sun gear 40 are arranged coaxially to each other while being allowed to rotate relatively to each other.

The carrier 39 is connected to the output shaft 13 of the engine 3. The first sun gear 37 is connected to the output shaft 4a of the first motor 4, and the second sun gear 40 is connected to the rotor shaft 25 of the second motor 5. The ring gear 38 is connected to the output gear 19. A rotation of the output shaft 13 of the engine 3 or the input shaft 14 is selectively stopped by the brake B1 as a dog brake.

Thus, in the powertrain 36 shown in FIG. 13, the first motor 4 and the second motor 5 are connected to the power split mechanism 6. In the vehicle Ve having the powertrain 36, therefore, a reaction torque may be established by the first motor 4 and the second motor 5 in the EV mode. That is, the vehicle Ve having the powertrain 36 is a compound-split hybrid vehicle.

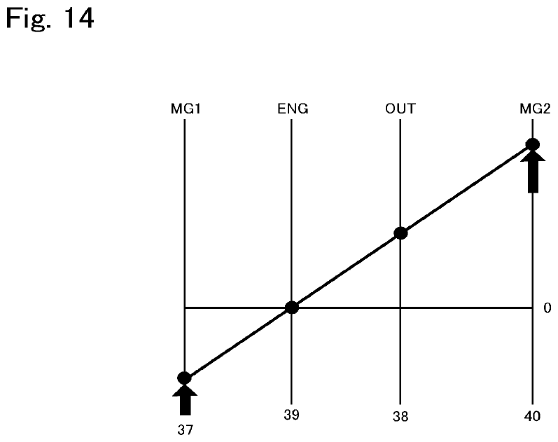

Rotational speeds of the rotary elements of the power split mechanism 6 shown in FIG. 13, and directions of torques of the engine 3, the first motor 4, and the second motor 5 in each operating mode of the vehicle Ve having the powertrain 36 are indicated in FIGS. 14 to 17. In the nomographic diagrams shown in FIGS. 14 to 17, distances among the vertical lines represents a gear ratio of the power split mechanism 6 shown in FIG. 13, a vertical distance on the vertical line from the horizontal base line represents a rotational speed of the rotary member, an orientation of the arrow represents a direction of the torque, and a length of the arrow represents a magnitude of the torque. Specifically, FIG. 14 shows a situation of the power split mechanism 6 shown in FIG. 13 in which both of the first motor 4 and the second motor 5 establish reaction torques during propulsion in the EV mode without engaging the brake B1. In this situation, if it is required to shift the operating mode to the HV mode, the operating mode may be shifted promptly to the HV mode without disengaging the brake B1.

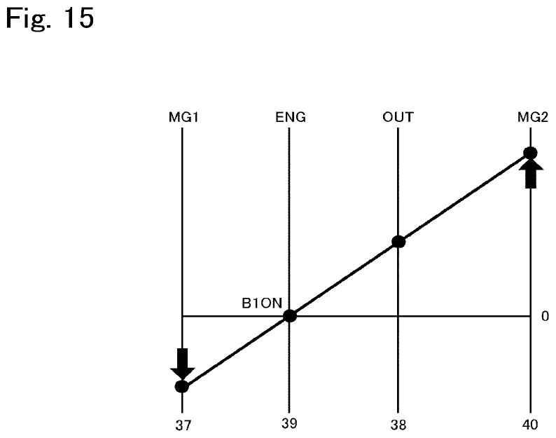

FIG. 15 shows a situation of the power split mechanism 6 shown in FIG. 13 during propulsion in the dual-motor mode in which the brake B1 is engaged. In this situation, both of the first motor 4 and the second motor 5 generate drive torques in the direction to propel the vehicle in the forward direction, and the brake B1 is engaged to establish a reaction torque to stop a rotation of the output shaft 13. In this case, since the brake B1 is engaged, both of the first motor 4 and the second motor 5 are allowed to generate drive torque as necessary.

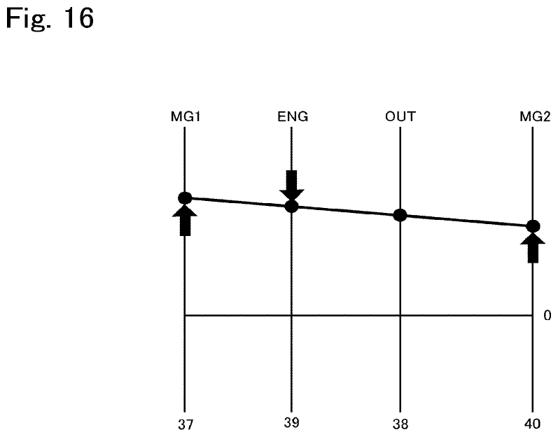

FIG. 16 shows a situation of the power split mechanism 6 shown in FIG. 13 when shifting the operating mode from the EV mode to the HV mode by starting the engine 3. In this situation, specifically, the engine 3 is cranked by the first motor 4, and the second motor 5 generates a drive torque to propel the vehicle Ve.

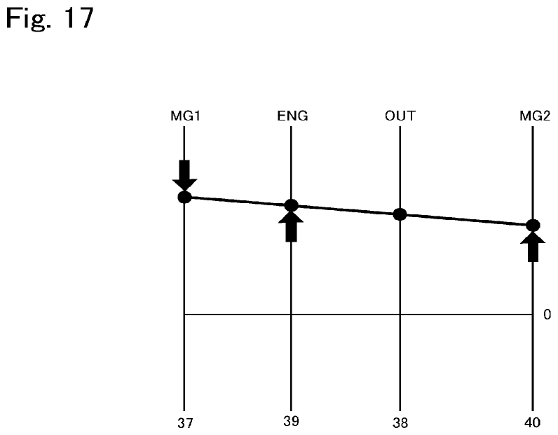

FIG. 17 shows a situation of the power split mechanism 6 shown in FIG. 13 after shifting the operating mode to the HV mode. In this situation, the engine 3 generates a drive torque to propel the vehicle Ve, and the first motor 4 and the second motor 5 establish reaction torques in such a manner as to optimize drive efficiency and energy efficiency in the powertrain 36. Since rotational speeds of the first motor 4 and the second motor 5 may be changed continuously, the power split mechanism 6 shown in FIG. 13 may serve as a continuously variable transmission.

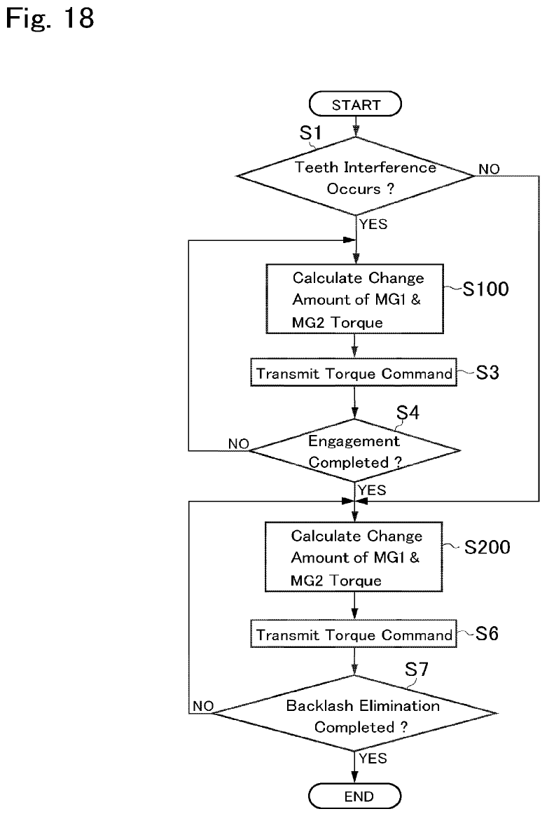

Procedures to engage the brake B1 and to eliminate the backlash in the brake B1 in the powertrain 36 are shown in FIG. 18. In the following explanation, detailed explanations for the steps in common with those of the routine shown in FIG. 11 will be omitted or simplified.

At step S1, it is determined whether a teeth interference is caused in the brake B1. If the teeth interference is caused in the brake B1 so that the answer of step S1 is YES, the routine progresses to step S100 to calculate a change amount of torque of the first motor 4 and a change amount of torque of the second motor 5 to shift the phase of e.g., the set of teeth on one half of the brake B1. As described, in the powertrain 36 shown in FIG. 13, the first motor 4 and the second motor 5 are connected to the power split mechanism 6. Therefore, the torque to shift the phase of the set of gear teeth on one half of the brake B1 may be generated not only by the first motor 4 but also by the second motor 5. In the powertrain 36, therefore, the first motor 4 and the second motor 5 may be controlled cooperatively to solve the teeth interference in the brake B1. For example, in order to shift the phase of the set of gear teeth on one half of the brake B1, the torque of the second motor 5 is maintained to a constant torque, and the torque of the first motor 4 is changed to adjust the torque to shift the phase of the set of gear teeth on one half of the brake B1. By contrast, the torque of the first motor 4 may be maintained to a constant torque, and the torque of the second motor 5 may be changed to adjust the torque to shift the phase of the set of gear teeth on one half of the brake B1.

Then, at step S3, a torque command to the first motor 4 is calculated by adding or subtracting the change amount of the torque of the first motor 4 calculated at step S100 to/from a required torque of the first motor 4. Likewise, a torque command to the second motor 5 is calculated by adding or subtracting the change amount of the torque of the second motor 5 calculated at step S100 to/from a required torque of the second motor 5. The torque commands thus calculated are transmitted from the main ECU 32 to the motor ECU 33. After the completion of the engaging operation of the brake B1, the routine progresses from step S4 to step S200 to calculate change amounts of the torques of the first motor 4 and the second motor 5 to eliminate the backlash between the teeth on one half of the brake B1 and the teeth on the other half of the brake B1.

That is, the torque to reduce the backlash in the brake B1 is generated by the first motor 4 and the second motor 5. To this end, for example, the torque of one of the first motor 4 and the second motor 5 may be maintained to a constant torque, and the torque of the other one the first motor 4 and the second motor 5 may be changed to adjust the torque to eliminate the backlash in the brake B1.

Then, at step S6, a torque command to the first motor 4 is calculated by adding or subtracting the change amount calculated at step S5 to a required torque of the first motor 4, and a torque command to the second motor 5 is calculated by adding or subtracting the change amount calculated at step S5 to a required torque of the second motor 5. The torque commands thus calculated is transmitted from the main ECU 32 to the motor ECU 33. When the completion of the backlash eliminating operation is determined at step S7, the routine terminates.

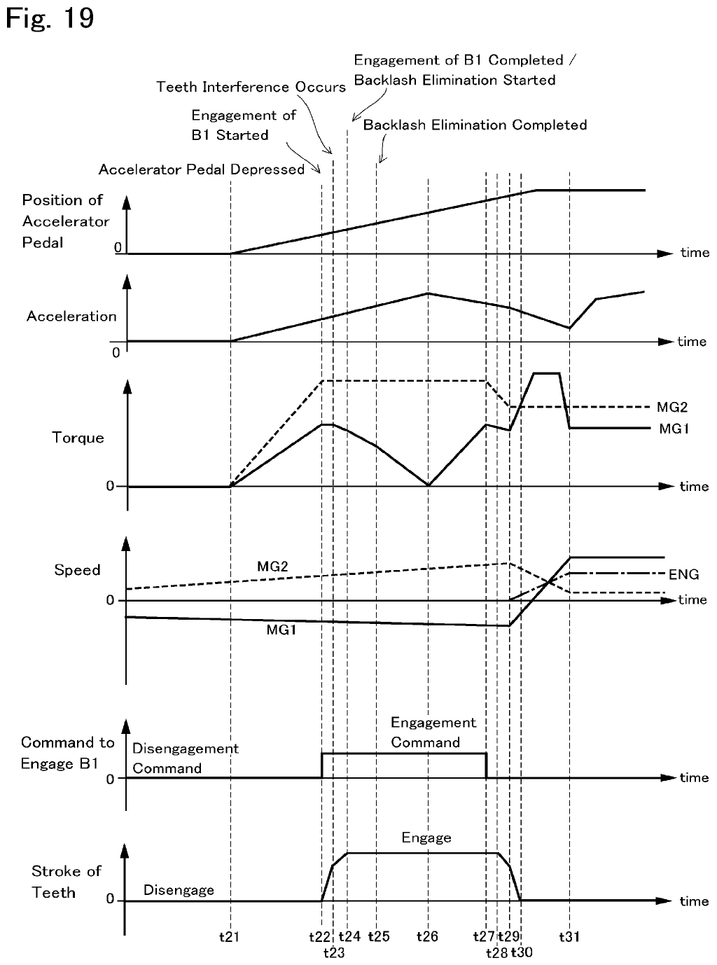

Next, a temporal change in situation of the vehicle Ve having the powertrains 36 shown in FIG. 13 during execution of the routine shown in FIG. 18 will be explained with reference to FIG. 19. Specifically, FIG. 19 shows an example of accelerating the vehicle Ve coasting in the single-motor mode.

At point t21, the accelerator pedal is depressed so that the acceleration of the vehicle Ve is increased gradually from point t21. In this situation, the second motor 5 generates a drive torque, and the first motor 4 establishes a reaction torque to stop a rotation of the output shaft 13 of the engine 3 as indicated in FIG. 14.

In the operating condition indicated in FIG. 14, a power circulation may be caused between the first motor 4 and the second motor 5. Therefore, in order to avoid such power circulation, a command signal to engage the brake B1 is transmitted at point t22 from the main ECU 32 to the clutch ECU 35 so as to shift the operating mode from the single-motor mode to the dual-motor mode. Consequently, the set of teeth on one half of the brake B1 starts moving toward the set of teeth on the other half of the brake B1. In this situation, the drive torque of the second motor 5 is increased with an increase in depression of the accelerator pedal, and reaches an upper limit value at point t22.

At point t23, the top land of each tooth on one half of the brake B1 is individually comes into contact to the top land of each tooth on the other half of the brake B1. At point t23, therefore, the torque of the first motor 4 is changed to shift the phase of the set of teeth on one half of the brake B1 so as to mate the set of teeth on one half of the brake B1 to the set of teeth on the other half of the brake B1. To this end, specifically, the torque of the second motor 5 is maintained to a constant torque from the point t22, and the torque of the first motor 4 is reduced slightly from point t23. In this situation, in order to further accelerate the vehicle Ve in the dual-motor mode with an increase in depression of the accelerator pedal, the torque of the first motor 4 has to be reduced toward zero. Therefore, in order to shift the phase of the set of teeth on one half of the brake B1, it is preferable to reduce the torque of the first motor 4 slightly toward zero.

Consequently, at point t24, the set of teeth on one half of the brake B1 is mated completely to the set of teeth on the other half of the brake B1, and the backlash eliminating operation is commenced. As described, in order to accelerate the vehicle Ve in the dual-motor mode, the torque of the first motor 4 is being reduced toward zero. Therefore, in order to eliminate the backlash in the brake B1, it is also preferable to further reduce the torque of the first motor 4 from point t24 toward zero.

The depression of the accelerator pedal is further increased, and at point t26, an engine starting flag is turned on. Consequently, in order to disengage the brake B1 smoothly, the load acting on the brake B1 is reduced by increasing to the toque of the first motor 4 to a magnitude substantially comparative to that before reduced at point t22. Then, the command signal to disengage the brake B1 is transmitted at point t27 from the main ECU 32 to the clutch ECU 35. As a result, at point t28, the set of teeth on one half of the brake B1 is withdrawn from the set of teeth on the other half of the brake B1.

When the set of teeth on one half of the brake B1 is isolated away from the set of teeth on the other half of the brake B1, the torque of the first motor 4 is further increased from point t29 in the forward direction to crank the engine 3 as indicated in FIG. 16. Then, the brake B1 is disengaged completely at point t30. Consequently, the operating mode is shifted from the dual-motor mode to the HV mode as indicated in FIG. 17.

Here, if it is expected that the accelerator pedal is depressed during coasting based on a driving record or the like, the brake B1 may be engaged before the accelerator pedal is depressed by the driver.

By thus executing the routine shown in FIG. 18, the above-explained advantage of the routine shown in FIG. 11. Specifically, the brake B1 may be engaged smoothly and certainly by adjusting the torque of at least one of the first motor 4 and the second motor 5. In addition, after engaging the brake B1, the backlash in the brake B1 may also be eliminated by further adjusting the torque of at least one of the first motor 4 and the second motor 5. To this end, specifically, the torque of at least one of the first motor 4 and the second motor 5 is changed slightly in a mild manner. Therefore, the set of teeth on one half of the brake B1 will not collide against the set of teeth on the other half of the brake B1, and collision noise in the brake B1 can be reduced when reducing the backlash. Here, in the case of engaging the brake B1 and eliminating the backlash in the brake B1 by adjusting the torque of only one of the motors while maintaining the torque of the other one of the motors as indicated in FIG. 19, the control burden may be reduced.

Although the above exemplary embodiments of the present disclosure have been described, it will be understood by those skilled in the art that the present disclosure should not be limited to the described exemplary embodiments, and various changes and modifications can be made within the scope of the present disclosure. For example, a direction of the torque to shift the phase of the set of teeth on one half of the engagement device should not limited to the specific direction. Likewise, the torque to eliminate the backlash in the brake B1 may be generated not only in the same direction as the direction of the torque to shift the phase of the set of teeth, but also in the opposite direction to the torque to shift the phase of the set of teeth.

What is claimed is:

1. A control system for a hybrid vehicle, comprising:
an engine;
a motor having a generating function;
a differential mechanism comprising an input element connected to the engine, a reaction element connected to the motor, and an output element connected to a pair of drive wheels; and
an engagement device that selectively stops a rotation of an output shaft of the engine by mating a set of teeth on one half to a set of teeth on the other half;
the control system comprising:
a controller that controls the motor and the engagement device,
wherein the controller is configured to
start mating the set of teeth on one half of the engagement device to the set of teeth on the other half of the engagement device when the engagement device is required to be engaged,
determine whether each tooth on one half of the engagement device is individually brought into contact to each tooth on the other half of the engagement device during engagement of the engagement device thereby causing an interference between the sets of teeth,
apply a torque to the set of teeth on one half of the engagement device to shift a phase of the set of teeth on one half of the engagement device if the interference between the sets of teeth is caused,
determine whether the engagement of the engagement device is completed, and
further apply the torque to the set of teeth on one half of the engagement device in a same direction as the torque to shift the phase of the set of teeth on one half of the engagement device, so as to reduce backlash between the set of teeth on one half of the engagement device and the set of teeth on the other half of the engagement device, when the engagement of the engagement device is completed.

2. The control system for the hybrid vehicle as claimed in claim 1, wherein the controller is further configured to maintain the torque to reduce the backlash between the sets of teeth for a predetermined period of time.

3. The control system for the hybrid vehicle as claimed in claim 1, wherein the controller is further configured to
generate the torque to shift the phase of the set of teeth on one half of the engagement device and the torque to reduce backlash between the sets of teeth by changing an output torque of the motor, and
set the torque to reduce backlash between the sets of teeth less than a maximum acceptable torque.

4. The control system for the hybrid vehicle as claimed in claim 1, wherein the controller is further configured to change the torque of the motor gradually to shift the phase of the set of teeth on one half of the engagement device, and to reduce backlash between the sets of teeth.

5. The control system for the hybrid vehicle as claimed in claim 1,
wherein the motor serves as a first motor,
the hybrid vehicle further comprises a second motor that is connected to the pair of drive wheels in a torque transmittable manner, and
the differential mechanism includes
a first planetary gear unit that performs a differential action among a first input element, a first reaction element, and a first output element, and
a second planetary gear unit that performs a differential action among a second input element, a second reaction element, and a second output element,
the first input element is connected to the engine,
the first reaction element is connected to the first motor,
the first output element is connected to the second input element, and
the second output element is connected to a member of the drive wheel side.

6. The control system for the hybrid vehicle as claimed in claim 1,
wherein the motor includes a first motor and a second motor,
the differential mechanism includes a planetary gear unit that performs a differential action among a first input element, a first reaction element, a first output element, and a second reaction element,
the first input element is connected to the engine,
the first reaction element is connected to the first motor,
the second reaction element is connected to the second motor, and
the first output element is connected to a member of the drive wheel side.

7. The control system for the hybrid vehicle as claimed in claim 6, wherein the controller is further configured to generate the torque to shift the phase of the set of teeth on one half of the engagement device by at least one of the first motor and the second motor.

8. The control system for the hybrid vehicle as claimed in claim 6, wherein the controller is further configured to generate the torque to reduce the backlash between the sets of teeth by at least one of the first motor and the second motor.

9. The control system for the hybrid vehicle as claimed in claim 5, wherein the controller is further configured to bring the engagement device into engagement when both of the first motor and the second motor generate torques in a direction to propel the hybrid vehicle in the forward direction.
